(19) United States
(12) Patent Application Publication
(10) Pub. No.: US 2013/0040111 A1
(43) Pub. Date: Feb. 14, 2013

(54) OPTICAL SHEET WITH ELASTICITY

(71) Applicants: Chang Won Park, Gyeonggi-do (KR); Kyung Jong Kim, Gyeonggi-do (KR); Chang Pyo Hong, Gyeonggi-do (KR)

(72) Inventors: Chang Won Park, Gyeonggi-do (KR); Kyung Jong Kim, Gyeonggi-do (KR); Chang Pyo Hong, Gyeonggi-do (KR)

(73) Assignee: KOLON INDUSTRIES, INC., Gwacheon-si, Gyeonggi-do (KR)

(21) Appl. No.: 13/638,807

(22) PCT Filed: Jun. 30, 2011
(86) PCT No.: PCT/KR11/04777

§ 371 Date: Oct. 23, 2012

(30) Foreign Application Priority Data
Jun. 30, 2010 (KR) 10-2010-0063204

(51) Int. Cl. B32B 3/30

(52) U.S. Cl. 428/172

(57) ABSTRACT

The present invention relates to an optical sheet with an elasticity and a photosensitive resin composition used for a liquid crystal display, in which the present invention has advantages that it can be easily handled because it cannot be easily damaged from an external impact; a production cost can be decreased and a production efficiency can be improved due to a decrease of error rate; and it can prevent the decrease of luminance due to a damage.

### TECHNICAL FIELD

The present invention relates to an optical sheet with an elasticity and a photosensitive resin composition used for a liquid crystal display (hereinafter, referred to as “LCD”).

### BACKGROUND ART

LCD used for a display device for optics uses an indirect light-emitting method that allows to display an image by controlling a transmission rate of the outside light source, and for LCD, a backlight unit that is an optical source device is being used as an important part for determining a property of LCD.

Especially, as technologies for manufacturing LCD panel develop, the demand for thin LCD display with high luminance is higher, and hence there have been many attempts to increase a luminance of the backlight unit. For a liquid crystal display used for various applications, such as a monitor, PDA (Personal Digital Assistant), a laptop, and the like, a barometer of superiority is to display bright light from a small energy source. Accordingly, a front luminance is very important in the case of LCD.

For LCD, light passed through an optical diffusing layer is structurally diffused in all directions so that LCD is extremely deficient in light displayed to its front. Accordingly, effects to display a higher luminance with small energy consumption are continuing. Furthermore, an effect to widen a viewing angle is performing to make a display to be large area so that more users can watch.

A power of backlight is increased to achieve this thereby increasing energy consumption and also increasing a loss of power due to heat. Accordingly, in the case of the portable display, a battery capacity become larger and battery life is shortened.

For this reason, a method for giving a directional property to light for increasing a luminance is suggested so that various lens sheets were developed. A typical sheet is one having a prism array, that is, the structure that arranges a number of hills and dales in a straight line side by side.

Here, the prism structure is a type of trigonal array having an inclined plane of around 45° for improving a luminance on the front direction. Accordingly, there was a problem that the tops of hills were easily broken or had worn down due to small external scratches because the top shape of prism structure is like mountain so that the construction of prism was damaged. Since angles exit from the prism structures having the same type are the same on each array, a luminance is deteriorated and a defective product is produced because the difference of light routes exit between the damaged part and normal part generated even by fine scratches occurred on the inclined planes or small crashed parts occurred on the edges of triangles. Therefore, the case of not using the front area of prism sheet produced according to a position may be sometimes caused by a fine poor thing on producing the prism sheet. For this reason, productivity may be decreased, and hence will burden on increasing production costs. Actually, for businesses to assembly backlight module, the poor products caused by the damage of prism construction due to scratches on handling the prism sheets have become a considerable problem.

Furthermore, many sheets and films should be laminated on the backlight unit and also multiple prism sheets can be installed in order to increasing a luminance. At this time, there is contact between the top of lower prism film and the bottom of upper prism film so that the problem to easily damage the prism construction was presented.

Accordingly, an existed protective film was laminated in order to prevent the damage of the prism construction as mentioned above. However, LCD panel is gradually slimmer so that the trend is to omit film or use the sheet having complex functions, and also there are problems that the production cost is increased, and time and physical efficiency is decreased because of adding laminating a protective film.

In addition to the damage of the prism construction due to handling on producing as mentioned above, the case of moving with a display in a bag is rapidly being increased according to the increase of using a portable display, such as a laptop and PDA. At this time, when an impact is applied to the display due to the running during moving, a sudden stop of car, and the like, there is a severe problem that the prism construction installed in the display is damaged thereby affecting on a screen even if the display has a protective film.

Accordingly, there is an urgent need for the prism construction that can flexibly cope with the outside impact.

### DISCLOSURE

### Technical Problem

Accordingly, the present invention provides an optical sheet with elasticity and a photosensitive resin composition to prevent a damage of structure layer so that when applying to a display, the display will not be affected by the outside impact.

Furthermore, the present invention provides the optical sheet with the elasticity and the photosensitive resin composition that can be easily handled because the damage of structure layer is prevented.

In addition, the present invention provides the optical sheet with the elasticity and the photosensitive resin composition that can maintain a function of prism construction because a decrease of luminance due to a difference of light route is prevented.

Meanwhile, the present invention provides the optical sheet with the elasticity that does not require a protective film.

In addition, the present invention provides the optical sheet with the elasticity that can reduce an error rate, decrease a production cost, and also increase production efficiency.

### Technical Solution

Hence, a preferable embodiment of the present invention provides an optical sheet produced from a curable material containing trifunctional acrylate compound having 3 to 15 of the number of ethylene oxide group and at least 85% of elastic recovery rate represented by the following Formula 1, in which the optical sheet includes a substrate layer, and a structure layer arranged with multiple stereo structures formed on one side or both sides of the substrate layer, and the upper side of stereo structure for the structure layer is pressurized with a pressurization rate of 0.203 mN/sec using a surface penetrator until reaching a maximum compressive force of 1 gf or 2 gf, and then when reaching the maximum compressive force, after it is pressurized for 5 seconds in the state of the maximum compressive force, the compressive force is removed and then the elastic recovery rate is measured on the structure layer treated as mentioned above.

$$Elastic Recovery Rate - \frac{{D}_{1} - {D}_{2}}{{D}_{1}} \times 100 \qquad [ Formula 1 ]$$

[wherein,

D₁ means the depth recessed by compressing through applying an external pressure, and D₂ means the difference between the height of the optical sheet that is not applied with the external pressure and a height of the optical sheet that is recovered after removing the external pressure]

For the optical sheet according to a preferable embodiment, an acid strength of the structure layer may be at least 200 g.

For the optical sheet according to a preferable embodiment, a trifunctional acrylate compound may be at least one compound selected from trimethylopropanetriacrylate, glycerine propoxylated triacrylate, and pentaerythritol triacrylate.

The optical sheet according to a preferable embodiment may have an elastic recovery rate of at least 90%, represented by Formula 1.

For the optical sheet according to a preferable embodiment, D₁ may be contented with the following Formula 2, more preferably D₁ may be contented with the following Formula 3, and most preferably D₁ may be contented with the following Formula 4.

$${D}_{1} \geq \frac{D}{20} \qquad [ Formula 2 ]$$

[wherein,

D means the height of the optical sheet in the state not applied with the external pressure]

$${D}_{1} \geq \frac{D}{19} \qquad [ Formula 3 ]$$

[wherein,

D means the height of the optical sheet in the state not applied with the external pressure]

$${D}_{1} \geq \frac{D}{17} \qquad [ Formula 4 ]$$

[wherein,

D means the height of the optical sheet in the state not applied with the external pressure]

For an embodiment of the present invention, a stereo structure may have at least one pattern selected from a polyhedral shape, of which its cross section is a polygon, a semicircle, or a semiellipse; a column shape, of which its cross section is a polygon, a semicircle, or a semiellipse; or a curve column shape, of which its cross section is a polygon, a semicircle, or a semiellipse.

### Advantageous Effects

The present invention can prevent a damage of the structure layer even if applying an external impact when applying to a display. Accordingly, the present invention is effective in not easily damaging with an external impact, such as a sudden stop when moving in a car or running with a bag including a portable display in the case of a portable display, such as a laptop and PDA.

Furthermore, the present invention is effective in preventing the damage of the structure layer thereby easily handling.

In addition, the present invention can prevent the decrease of luminance due to the damage, and hence the function of optical sheet can be maintained.

Meanwhile, the present invention has advantages that the production process may be simple, the production cost may be decreased, and also the production efficiency may be improved because a protective film is not required.

In addition, the present invention can reduce the production cost and improve the production efficiency because it is easily not damaged from an external impact or film lamination on producing thereby reducing an error rate.

### DESCRIPTION OF DRAWINGS

The above and other objects, features and advantages of the present invention will become apparent from the following description of preferred embodiments given in conjunction with the accompanying drawings, in which:

FIG. 1 is a mimetic diagram of a method for evaluating an acid strength.

Hereinafter, the embodiments of the present invention will be described in more detail.

An embodiment of the present invention provides an optical sheet produced from a curable material containing trifunctional acrylate compound having 3 to 15 of the number of ethylene oxide group and at least 85% of elastic recovery rate represented by the following Formula 1, in which the optical sheet includes a substrate layer, and a structure layer arranged with multiple stereo structures formed on one side or both sides of the substrate layer, and the upper side of stereo structure for the structure layer is pressurized with a pressurization rate of 0.203 mN/sec using a surface penetrator until reaching a maximum compressive force of 1 gf or 2 gf, and then when reaching the maximum compressive force, after it is pressurized for 5 seconds in the state of the maximum compressive force, the compressive force is removed and then the elastic recovery rate is measured on the structure layer treated as mentioned above.

$$Elastic Recovery Rate - \frac{{D}_{1} - {D}_{2}}{{D}_{1}} \times 100 \qquad [ Formula 1 ]$$

[wherein,

D₁ means the depth recessed by compressing through applying an external pressure, and D₂ means the difference between the height of the optical sheet that is not applied with the external pressure and a height of the optical sheet that is recovered after removing the external pressure]

For an optical sheet including a structure layer arranged with multiple stereo structures, when the cross section of the stereo structure is a polygon, it can be easily damaged from an external impact because the top of the optical sheet is a hatch shape like a mountain type, but if applying the force as mentioned above, the optical sheet according to the present invention may have an elasticity as well as may be contented with a scratch resistance so that it can tolerate the fixed load range.

For this reason, the optical sheet according to the present invention has preferably at least 85% of elastic recovery rate represented by the above Formula 1, and more preferably at least 90% of elastic recovery rate represented by the above Formula 1, in which the upper side of stereo structure for the structure layer is pressurized with the pressurization rate of 0.2301 mN/sec using the surface penetrator until reaching a maximum compressive force of 1 gf or 2 gf, and then when reaching the maximum compressive force, after it is pressurized for 5 seconds in the state of the maximum compressive force, the compressive force is removed and then the elastic recovery rate is measured on the structure layer treated as mentioned above.

When the optical sheet according to the present invention is contented with the elastic recovery rate after pressurizing and then removing the pressure as mentioned above, the optical sheet can prevent the damage of the structure layer due to the elasticity for being flexible in responding to the external impact even if applying the external impact.

Meanwhile, when the optical sheet is not contented with the elastic recovery rate after pressurizing and then removing the pressure as mentioned above, it is possible that it cannot perform its function as the optical sheet in the state of pressing the top of the structure layer in the case of contacting other film or receiving a load.

Meanwhile, it includes a trifunctional acrylate compound having 3 to 15 of the number of the ethylene oxide group in the curing materials for forming the structure layer for satisfying the scratch resistance.

The viscosity of the compound itself within the above range of a number of ethylene oxide group out of the trifunctional acrylate compounds is 50˜200 cps, so that it can ultimately decrease to be 600˜800 cps of the viscosity of the curable composition, and hence the a processability can be improved. The structure layer produced from the above composition has a good ductility so that preferably it is suitable to giving the elasticity to the optical sheet.

A specific example of the trifunctional acrylate compound may include trimethylopropanetriacrylate, glycerine propoxylated triacrylate, pentaerythritol triacrylate, and the like.

For the structure layer including the trifunctional acrylate compound having 3 to 15 of a number of ethylene oxide groups out of the curable material while satisfying the fixed elasticity property as mentioned above, the acid strength can be at least 200 g.

A method for measuring a specific acid strength will be described in detail in the following Example.

Meanwhile, a curable material to form the structure layer that can satisfy the elastic recovery rate as mentioned above is not limited especially, but for example, a molecular structure having a difunctional monomer repeatedly binding flexible alkylene glycol chains in the molecular can improve the elasticity. Especially, when the compound represented the following Chemical Formula 1 is included as a material for the structure layer; it can meet the elastic recovery rate and also cannot hinder the optical property.

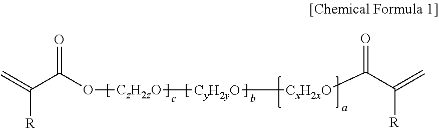

[wherein,

R is hydrogen atom, or alkyl group having 1˜15 of carbon number; x, y, and z are an integer of at least 0; and a, b, and c are an integer of at least a+b+c>4 or in the case of a+b+c<4, one of x, y, and z is at least 3]

The compound of the above Chemical Formula 1 has a molecular weight of 150˜10,000, and can increase the elasticity after curing by controlling a length and type of fixable alkylene oxide chain in the molecular structure. Also, its heat resistance and light resistance are excellent so that it is preferable as a material for forming the structure layer of the optical sheet.

In addition, for the optical sheet according to the present invention, D₁ that means the depth recessed by pressurizing through applying the external pressure is preferably contented with the following Formula 2, more preferably is contented with the following Formula 3, and most preferably is contented with the following Formula 4.

$${D}_{1} \geq \frac{D}{20} \qquad [ Formula 2 ]$$

[wherein,

D means the height of the optical sheet in the state not applied with the external pressure]

$${D}_{1} \geq \frac{D}{19} \qquad [ Formula 3 ]$$

[wherein,

D means the height of the optical sheet in the state not applied with the external pressure]

$${D}_{1} \geq \frac{D}{17} \qquad [ Formula 4 ]$$

[wherein,

D means the height of the optical sheet in the state not applied with the external pressure]

That is, if the optical sheet according to the present invention has an flexibility to be at least 1/20 depth, which is recessed by applying the external pressure, of the optical sheet height in the state of not applying the external pressure, it may be the better for maintaining a normal shape of the top of the structure layer when contacting with other film or receiving a load.

Consequentially, the optical sheet according to the present invention is not damaged according to the external impact because the structure layer having a stereo structure is easily recessed when it receives a load, but when the pressure state is removed; it is recovered to be closely backed to its former state. Furthermore, it can meet the scratch resistance.

The optical sheet according to the present invention may preferably include 5˜80 wt % of the compound of the above Chemical Formula 1 based on total weight of compositions for forming the structure layer to meet the elastic recovery rate as mentioned above. When including less than 5 wt %, the increase of elastic recovery rate may be insignificant; and when including at least 80 wt %, the effect on increasing the luminance as the optical sheet may be insignificant.

Meanwhile, for implementing useful elasticity and viscosity for the processability, the trifunctional acrylate compound having 3 to 15 of a number of ethylene oxide group may be included in 30 to 80 wt % based on total weight of compositions for forming the structure layer.

Moreover, the composition for forming the structure layer may further include a general UV curing agent, a photo initiator, and a high refraction resin having at least 1.52 of refractive index in addition to the trifunctional acrylate compound having a controlled number of ethylene oxide group, and the compound of the above Chemical Formula 1.

A method for manufacturing the optical sheet according to the present invention is not limited especially, but for example the optical sheet may be manufactured by curing after coating a curable liquid composition on the substrate layer after producing the curable liquid composition by adding an additive, such as UV curing agent to the material for the structure layer.

Meanwhile, the optical sheet according to the present invention may include the structure layer having multiple stereo constructions as a resin curing layer, of which its surface is structured, and may be a polyhedral shape, of which the cross section of the structure layer is a polygon, a semicircle, or a semiellipse; a column shape, of which its cross section is a polygon, a semicircle, or a semiellipse; or a curve column shape, of which its cross section is a polygon, a semicircle, or a semiellipse. Furthermore, it may be a mixed shape of at least one pattern out of the above shapes.

Furthermore, it may have the structure arranged in at least one concentric circle shape when looking from the plane and also may include the structure forming hills and dales along with the concentric circle.

When the cross section of the structure layer is a polygon, the change of property, such as the luminance and light viewing angle is significant according to an angle of vertex so that the angle of vertex may be preferably 80˜100° considering the luminance and light viewing angle by collecting light, and more preferably 85˜95°.

The substrate layer of the optical sheet may be formed by using at least one selected from the group consisting of polyethyleneterephthalate, polyethylenenaphthalate, polycarbonate, polystyrene, polymethacrylate, polymethylmethacrylate, polyacrylate, polyimide, and polyamide, and may also form the structure forming an uneven shape by further including light diffusing particles.

### BEST MODE

Hereinafter, the present invention will be described with reference to Examples, but the range of the present invention will not be limited to Examples.

### Producing Example of Acrylate Oligomer

### Synthesizing Example

A compound having a desired structure could be synthesized through a reflux reaction of 2.2 mole of CH₂═CH(R)COCl to 1 mole of HO—[CzH₂zO]c-[CyH₂yO]b-[CxH₂xO]a-H compound for about 5 hours in the presence of solvent, that is, tetrahydrofurane using a reactor. After the reaction, non-reacted CH₂═CH(R)COCl and solvent were filtered by using a filter, and then removed after a distillation under reduced pressure to synthesize the structure having the above Chemical Formula 1. At this time, the variable compounds were synthesized as the following Table 1:

TABLE 1

| | | | | Viscosity |
|---|---|---|---|---|
| Syn. | | | Yield | (mPaS/ |
| Ex. | HO—R—OH | CH₂═CH(R)COCl | (%) | 25° C.) |
| 1 | x = 2, y, z = 0, a = 4, | R═H | 93.5 | 25 |
| | b, c = 0 | | | |
| 2 | x = 2, y, z = 0, a = 9, | | 95.8 | 58 |
| | b, c = 0 | | | |
| 3 | x = 2, y, z = 0, a = 14, | | 97.0 | 106 |
| | b, c = 0 | | | |
| 4 | x = 2, y, z = 0, a = 23, | | 92.8 | 100/40° C. |
| | b, c = 0 | | | |
| 5 | x = 2, y, z = 0, a = 4, | R═CH₃ | 93.5 | 50 |
| | b, c = 0 | | | |
| 6 | x = 3, y, z = 0, a = 2, | R═H | 97.5 | 8 |
| | b, c = 0 | | | |
| 7 | x = 3, y, z = 0, a = 3, | | 96.3 | 12 |
| | b, c = 0 | | | |
| 8 | x = 3, y, z = 0, a = 7, | | 95.2 | 34 |
| | b, c = 0 | | | |
| 9 | x = 3, y, z = 0, a = 12, | | 94.6 | 68 |
| | b, c = 0 | | | |
| 10 | x = 3, y, z = 0, a = 7, | R═CH₃ | 96.7 | 30 |
| | b, c = 0 | | | |
| 11 | x, z = 2, y = 4, a, b, | R═H | 95.5 | 10 |
| | c = 1 | | | |
| 12 | x, z = 2, y = 4, a, b, | R═CH₃ | 94.6 | 10 |
| | c = 1 | | | |
| 13 | x = 5, y, z = 0, a = 1, | R═H | 96.5 | 6 |
| | b, c = 0 | | | |
| 14 | x = 9, y, z = 0, a = 1, | R═H | 94.5 | 20 |
| | b, c = 0 | | | |

*HO—R—OH [symbol] HO—[CzH₂zO]c—[CyH₂yO]b—[CxH₂xO]a—H

### Manufacturing Optical Sheet

### Example 1-14

The composition was produced by mixing 30 parts by weight of acrylate obtained from Synthesizing Examples 1-14, 35 parts by weight of bisphenol A type diacylate (M-2100, Miwon Company), 30 parts by weight of trimethylopropanetriacylate (6 ethylene oxide groups), 1.5 parts by weight of a photo initiator, i.e., 2,4,6-trimethylbenzoyl diphenylphosphineoxide, 1.5 parts by weight of a photo initiator, i.e., methylbenzoylformate, and 2.0 parts by weight of additive, i.e., bis(1,2,2,6,6-pentamethyl-4-piperidyl)sebacate, based on 100 parts by weight of total composition, and then mixing for 1 hour at 60° C. And then, it applied to one side of polyethyleneterephthalate (KOLON Company, Thickness 188 μm) that is a substrate layer; it was placed on a frame of prism shape roller at 35° C.; UV of 900 mJ/cm² irradiates from the direction of substrate layer by installing type-D bulb in UV irradiation device (Fusion Company, 600 Watt/inch²); and a linear triangle prism having a vertical angle of 90°, pitch of 50 μm, and a height of 27 μm to produce an optical sheet (D=215 μm).

### Example 15

An optical sheet was manufactured by forming a lenticular lens using components of Example 3 applied with the above Synthesizing Example 3, in which the lenticular lens had the cross section of the semicircular, the pitch of 50 μm and the height of 27 μm.

### Example 16

An optical sheet was manufactured by forming a linear prism using components of Example 3 applied with the above Synthesizing Example 3, in which the linear prism had the cross section of the semiellipse, the pitch of 50 μm and the height of 27 μm.

### Example 17

An optical sheet was manufactured by forming a linear prism using components of Example 3 applied with the above Synthesizing Example 3, in which the linear prism had the cross section of the pentagon, the vertical angle of 95°, the pitch of 50 μm and the height of 27 μm.

### Example 18

An optical sheet was manufactured by forming a prism of wave shape arrangement using components of Example 3 applied with the above Synthesizing Example 3, in which the prism of wave shape arrangement had the cross section of the semicircular, the pitch of 50 μm and the height of 27 μm.

### Example 19

An optical sheet was manufactured by using the same method with the above Example 1, except using trimethylopropanetriacrylate compound having 10 of a number of ethylene oxide groups as a trifunctional acrylate compound.

### Example 20

An optical sheet was manufactured by using the same method with the above Example 1, except using trimethylopropanetriacrylate compound having 15 of a number of ethylene oxide groups as a trifunctional acrylate compound.

### Example 21

An optical sheet was manufactured by using the same method with the above Example 1, except using glycerine propoxylated triacrylate compound having 6 of a number of ethylene oxide groups as a trifunctional acrylate compound.

### Example 22

An optical sheet was manufactured by using the same method with the above Example 1, except using pentaerythritol triacrylate compound having 6 of a number of ethylene oxide groups as a trifunctional acrylate compound.

### Comparative Example 1

A prism film, BEF III to be supplied from 3M Company was used as an optical sheet (D=215 μm).

### Comparative Example 2

A prism film, Brtie-200 to be supplied from Dusan Company was used as an optical sheet (D=215 μm).

### Comparative Example 3

A prism film, LES-T2 to be supplied from LG Company was used as an optical sheet (D=220 μm).

An acid strength about the optical sheets obtained from each of Examples and Comparative Examples was measured as follows, and then the results were shown in the following Table 2.

(1) Evaluation of Acid Strength

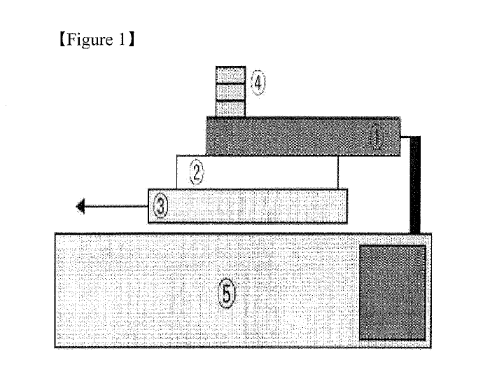

An optical sheet to be evaluated was fixed on a measuring instrument like the type as shown in FIG. 1.

FIG. 1 shown parts as follows: \textcircled{1} Up sheet (25% Haze pol.), \textcircled{2} Evaluation sheet (Examples and Comparative Examples sheets, vertical cutting at moving direction), \textcircled{3} Mobile Support (Glass plate, Movement Velocity 30 cm/min), \textcircled{4} Counterweight (10 g, 50 g Laminating, Contact Part Radius 20 mm), \textcircled{5} Measuring Instrument TOYOSEIKI for Coefficient of Friction.

Firstly, a sample to be measured (\textcircled{2}) was placed on the top of structure layer and then fixed (using a tape) at a constant position on a mobile support (\textcircled{3}). Next, Haze treating side of Up sheet (\textcircled{1}) was faced the structure layer, and then fixed to a latch of the measuring instrument. Next, a counterweight (\textcircled{4}) was laminated on the top of Up sheet (\textcircled{1}), and then the mobile support (\textcircled{3}) was moved at a constant speed.

A result evaluated was confirmed as follows:

1. Confirmation of Damage Part with Naked Eye

2. Confirmation of Damage of Sample after dark of BLU (Light Guide Plate/Diffusing Sheet)

3. Confirmation with Microscope/SEM in the case of Fine Damage

4. Definition of Acid Strength with Maximum Counterweight Weight, of which the damage is not found.

(2) D₁ and Elastic Recovery Rate

D₁ and an elastic recovery rate about the optical sheets manufactured from Examples and Comparative Examples were measured by using ‘Load-Unload test’ Item through using Micro Hardness Tester to be supplied from Japan (Shimadzu DUH-W201S). A hatch part having a mountain shape of the structure layer of optical sheet was positioned at the center part of surface penetrator having a diameter of 50 μm, and then D₁ and the elastic recovery rate were repeatedly measured 5 times under the following conditions, and the results were shown in the following Table 2.

[Measurement Condition 1]

a. Maximum Compressive Force applied: 1 gf(=9.807 mN)

b. Compressive Force applied per hour: 0.2031 mN/sec

c. Time stopped at Maximum Compressive Force: 5 sec

[Measurement Conditions 2]

a. Maximum Compressive Force applied: 2 gf(˜19.614 mN)

b. Compressive Force applied per hour: 0.2031 mN/sec

c. Time stopped at Maximum Compressive Force: 5 sec

TABLE 2

| | | | Measurement Conditions 1 | | | Measurement Conditions 2 | | |
|---|---|---|---|---|---|---|---|---|
| | | | | | Elastic | | | Elastic |
| | Acid | | | | Recovery | | | Recovery |
| Section | Strength | D(μm) | D₁(μm) | D₂(μm) | Rate (%) | D₁(μm) | D₂(μm) | Rate (%) |
| Ex. 1 | 250 g | 215 | 10 | 1.2 | 88 | 13 | 1.8 | 86 |
| Ex. 2 | 250 g | 215 | 10 | 1.2 | 88 | 13 | 1.8 | 86 |
| Ex. 3 | 300 g | 215 | 14 | 0.7 | 95 | 18 | 1.3 | 93 |
| Ex. 4 | 300 g | 215 | 11 | 1.2 | 89 | 14 | 1.8 | 87 |
| Ex. 5 | 250 g | 215 | 10 | 1.3 | 87 | 13 | 2.0 | 85 |
| Ex. 6 | 250 g | 215 | 10 | 1.2 | 88 | 12 | 1.7 | 86 |
| Ex. 7 | 250 g | 215 | 10 | 1.2 | 88 | 13 | 1.8 | 86 |
| Ex. 8 | 250 g | 215 | 13 | 1.0 | 92 | 16 | 1.6 | 90 |
| Ex. 9 | 300 g | 215 | 14 | 0.7 | 95 | 18 | 1.3 | 93 |
| Ex. 10 | 300 g | 215 | 10 | 1.2 | 88 | 12 | 1.7 | 86 |
| Ex. 11 | 300 g | 215 | 12 | 1.2 | 90 | 15 | 1.8 | 88 |
| Ex. 12 | 300 g | 215 | 10 | 1.3 | 87 | 13 | 2.0 | 85 |
| Ex. 13 | 250 g | 215 | 12 | 1.2 | 90 | 14 | 1.7 | 88 |
| Ex. 14 | 300 g | 215 | 13 | 0.9 | 93 | 16 | 1.4 | 91 |
| Ex. 15 | 300 g | 215 | 12 | 1.2 | 90 | 15 | 1.8 | 88 |
| Ex. 16 | 300 g | 215 | 12 | 1.1 | 91 | 15 | 1.7 | 89 |
| Ex. 17 | 300 g | 215 | 11 | 1.2 | 89 | 14 | 1.8 | 87 |
| Ex. 18 | 300 g | 215 | 12 | 1.2 | 90 | 15 | 1.8 | 88 |
| Ex. 19 | 300 g | 215 | 13 | 1.0 | 92 | 16 | 1.6 | 90 |
| Ex. 20 | 500 g | 215 | 14 | 0.7 | 95 | 19 | 1.3 | 93 |
| Ex. 21 | 248 g | 215 | 10 | 1.2 | 88 | 13 | 1.8 | 86 |
| Ex. 22 | 250 g | 215 | 10 | 1.2 | 88 | 13 | 1.8 | 86 |
| Com. Ex. 1 | 20 g | 215 | 2.892 | 0.699 | 75.8 | 3.502 | 0.903 | 74.2 |
| Com. Ex. 2 | 10 g | 215 | 4.846 | 1.187 | 75.5 | 5.235 | 1.188 | 77.3 |
| Com. Ex. 3 | 10 g | 220 | 4.389 | 1.198 | 72.7 | 5.200 | 1.346 | 74.1 |

1. An optical sheet comprising a substrate layer, and a structure layer arranged with multiple stereo structures formed on one side or both sides of the substrate layer;
wherein the structure layer has at least 85% of elastic recovery rate represented by the following Formula 1, wherein the upper side of stereo structure for the structure layer is pressurized with a pressurization rate of 0.203 mN/sec using a surface penetrator until reaching a maximum compressive force of 1 gf or 2 gf, and then when reaching the maximum compressive force, after it is pressurized for 5 seconds in the state of the maximum compressive force, the compressive force is removed and then the elastic recovery rate is measured on the structure layer;
the optical sheet is produced from a curable material containing trifunctional acrylate compound having 3 to 15 of the number of ethylene oxide group:
$$Elastic Recovery Rate - \frac{{D}_{1} - {D}_{2}}{{D}_{1}} \times 100 \qquad Formula 1$$
wherein,
D₁ means the depth recessed by compressing through applying an external pressure, and D₂ means the difference between the height of the optical sheet that is not applied with the external pressure and a height of the optical sheet that is recovered after removing the external pressure.

2. The optical sheet according to claim 1, wherein an acid strength of the structure layer is at least 200 g.

3. The optical sheet according to claim 1, wherein the trifunctional acrylate compound is at least one compound selected from the group consisting of trimethylopropanetriacrylate, glycerine propoxylated triacrylate, and pentaerythritoltriacrylate.

4. The optical sheet according to claim 1, wherein the elastic recovery rate represented by Formula 1 is at least 90%.

5. The optical sheet according to claim 1, wherein D₁ is contented with the following Formula 2:
$${D}_{1} \geq \frac{D}{20} \qquad Formula 2$$
wherein,
D means the height of the optical sheet in the state not applied with the external pressure.

6. The optical sheet according to claim 1, wherein D₁ is contented with the following Formula 3:
$${D}_{1} \geq \frac{D}{19} \qquad Formula 3$$
wherein,
D means the height of the optical sheet in the state not applied with the external pressure.

7. The optical sheet according to claim 1, wherein D₁ is contented with the following Formula 4:
$${D}_{1} \geq \frac{D}{17} \qquad Formula 4$$
wherein,
D means the height of the optical sheet in the state not applied with the external pressure.

8. The optical sheet according to claim 1, wherein the stereo structure has more than one pattern from a polyhedral shape, of which the cross section of the structure layer is a polygon, a semicircle, or a semiellipse; a column shape, of which its cross section is a polygon, a semicircle, or a semiellipse; or a curve column shape, of which its cross section is a polygon, a semicircle, or a semiellipse.

9. The optical sheet according to claim 2, wherein the trifunctional acrylate compound is at least one compound selected from the group consisting of trimethylopropanetriacrylate, glycerine propoxylated triacrylate, and pentaerythritoltriacrylate.

10. The optical sheet according to claim 2, wherein the elastic recovery rate represented by Formula 1 is at least 90%.

11. The optical sheet according to claim 2, wherein D₁ is contented with the following Formula 2:
$${D}_{1} \geq \frac{D}{20} \qquad Formula 2$$
wherein, D means the height of the optical sheet in the state not applied with the external pressure.

12. The optical sheet according to claim 2, wherein D₁ is contented with the following Formula 3:
$${D}_{1} \geq \frac{D}{19} \qquad Formula 3$$
wherein, D means the height of the optical sheet in the state not applied with the external pressure.

13. The optical sheet according to claim 2, wherein D₁ is contented with the following Formula 4:
$${D}_{1} \geq \frac{D}{17} \qquad Formula 4$$
wherein, D means the height of the optical sheet in the state not applied with the external pressure.
